(19) United States
(12) Patent Application Publication
(10) Pub. No.: US 2008/0010901 A1
(43) Pub. Date: Jan. 17, 2008

(54) Drive for a Sliding Door

(76) Inventor: Jurgen Althammer, Kraiburg (DE)

Correspondence Address: OSTROLENK FABER GERB & SOFFEN, 1180 AVENUE OF THE AMERICAS, NEW YORK, NY, 100368403, US

(21) Appl. No.: 10/556,369

(22) PCT Filed: May 10, 2004
(86) PCT No.: PCT/EP04/04979

§ 371 Date: Mar. 19, 2007

(30) Foreign Application Priority Data
May 10, 2003 (DE) 103 21 037.7

(51) Int. Cl. E05F 15/14

(52) U.S. Cl. 49/360

(57) ABSTRACT

A drive for a sliding door comprises a drive motor, which has a rotating drive element that is coupled to a sliding door sash in order to drive the sash in horizontal directions of movement. In order to move it in horizontal direction, said door sash is guided on a guide track. The door sash is guided on the guide track via a guiding element having a surface, which extends in the direction of movement and which has a length that is at least equal to the desired movement distance. The surface is engaged with a friction wheel, which forms the drive element of the drive motor and which is pretensioned against the surface by resilient devices.

The invention relates to a drive for a sliding door of the type specified in the preamble of claim 1.

Known sliding doors, for example in CH 687 266 A5, are driven by a drive motor which, for example, drives a circulating chain via a chain wheel, the door sash being connected to one part of the chain in such a way that, upon a revolution of the drive element of the motor, the one part of the chain and with it the door sash are driven in a reciprocating motion.

However, drives of this kind can be cleaned only with difficulty, so that they are rather unsuitable for use in the medical sector, for example for the doors of cleaning, disinfecting and drying installations, and generally for sliding doors.

The object of the invention is to make available a drive of the type mentioned at the outset which comprises a small number of parts and is easy to clean.

This object is achieved by the features set forth in patent claim 1.

Advantageous embodiments and developments of the invention are set forth in the dependent claims.

By virtue of the inventive configuration of the drive, cleaning is made very easy, because only a small number of parts are used, and these parts can be largely surrounded by smooth surfaces which are easy to clean.

Moreover, no additional safety devices are required to protect the door against jamming, since the friction wheel drive forms a safety friction coupling.

The invention is explained in more detail below on the basis of an illustrative embodiment shown in the drawing, in which:

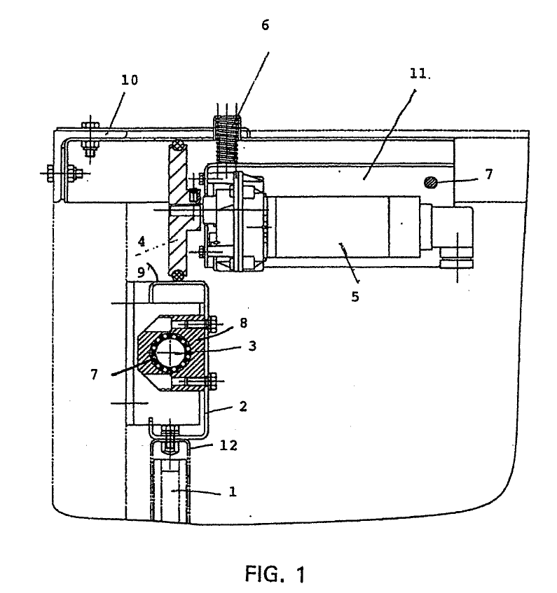

FIG. 1 shows a simplified, partially sectioned side view of an embodiment of the drive,

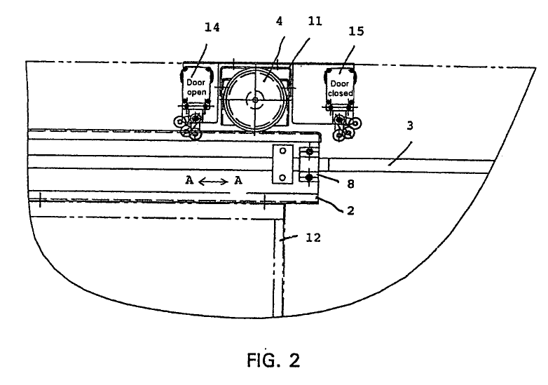

FIG. 2 shows a view of the embodiment of the drive according to FIG. 1 from the left, parts having been omitted in order to better illustrate the essence of the subject of the application.

FIG. 1 shows an embodiment of a drive for a door sash 1 of a sliding door of which only the top edge is depicted. The top edge of the door sash 1 is secured on a guiding element 2 which basically has the shape of a letter U lying on its side, one branch of the U being secured on the top edge of the door sash 1, while the opposite upper branch forms a surface 9 designed to engage with a friction wheel 4 of a drive motor 5. The guiding element 2 is guided on a guide track 3 via a linear guide 7, 8 with ball bearings 7, and the guiding element 2 surrounds the linear guide 7, 8 and the guide track 3 and, if appropriate, can be closed on its open front by a cover element.

The drive motor 5 is secured in a support fixture 11 which, at that end of the motor remote from the friction wheel 4, is mounted on a door frame 10 via a shaft 7 which extends in the direction of movement of the door sash 1 and is parallel thereto, which door frame 10 is shown only partially and schematically.

In this way, the friction wheel 4 is pressed, by the inherent weight of the drive motor, against the surface 9 of the guiding element 2. In addition, the friction wheel 4 can be pretensioned adjustably against the surface 9 by a spring 6 which presses that end of the drive motor 5 and/or the support fixture adjacent to the friction wheel 4 in the direction toward the guiding element 2, and that end of the spring 6 remote from the support fixture 11 or from the drive motor 5 bears on the door frame 10.

Because of this kind of guide, the lower end of the door sash does not require any special guide devices, such that the lower guide devices can be formed for example by a plastic profile which engages around the lower edge of the door sash 1. This door sash can, for example, be a double-walled Thermoglas door with a stainless steel surround 12 whose top edge can be used for securing it on the guiding element 2.

The drive motor 5 can be a slowly turning geared motor which drives the friction wheel 4, this friction wheel being provided on the circumference with a friction ring 13 which is made of suitable elastic material which securely engages with the surface 9 of the guiding element 2.

By virtue of the elastic pretensioning of the drive motor 5 by the spring 6 and/or by the inherent weight of the drive motor, the force with which the friction wheel 4 presses against the surface 9 can be adjusted, with the result that separate safety devices are not required since, in the event of resistance against the movement of the door sash 1, slipping occurs between the friction wheel 4 and the surface 9.

As is shown in FIG. 2, stops can be provided on the guiding element 2 which come into engagement with limit stop switches 14, 15 upon opening and closing, respectively, of the door.

1. A drive for a sliding door, with a drive motor which has a rotatable drive element coupled to a sliding door sash in order to drive the latter in horizontal directions of movement, the door sash being guided on a guide track for a movement in the horizontal direction, wherein the door sash is guided on the guide track via a guiding element having a surface which extends in the direction of movement and which has a length at least equal to the desired movement distance, in that the surface engages with a friction wheel which forms the drive element of the drive motor, and in that the friction wheel is pretensioned against the surface by resilient devices.

2. The drive as claimed in claim 1, wherein the guiding element is guided on the guide track via a linear bearing.

3. The drive as claimed in claim 1, wherein the guiding element is arranged on the top of the door sash, and in that the bottom of the door sash is guided in a guide profile.

4. The drive as claimed in claim 1 wherein the guiding element encloses the guide track and linear bearing, its top having said surface and its bottom being connected to the top edge of the door sash.

5. The drive as claimed in claim 1, wherein the motor is secured on a support fixture which, at a distance from the friction wheel, is mounted on a door frame via a horizontal shaft extending substantially parallel to the direction of movement of the door sash, while the end of the motor adjacent to the friction wheel is pretensioned in the direction toward the guiding element by the inherent weight of the motor and/or by a spring.
